(19) United States
(12) Patent Application Publication
(10) Pub. No.: US 2025/0202131 A1
(43) Pub. Date: Jun. 19, 2025

(54) INTEGRATED ANTENNA ARRAY WITH FEED AND CALIBRATION NETWORKS

(71) Applicant: Syntronic Research and Development Canada Inc., Kanata (CA)

(72) Inventors: Babak ZARRIN RAFIE, Ottawa (CA); Elham BALADI, Kanata (CA); Behnam GOHARFAR, Kanata (CA)

(73) Assignee: Syntronic Research and Development Canada Inc., Kanata (CA)

(21) Appl. No.: 18/980,025

(22) Filed: Dec. 13, 2024

Related U.S. Application Data
(60) Provisional application No. 63/610,453, filed on Dec. 15, 2023.

(51) Int. Cl. H01Q 21/06; H04B 17/12; H04B 17/21

(52) U.S. Cl. CPC H01Q 21/06; H04B 17/12; H04B 17/221

(57) ABSTRACT

The present disclosure provides an integrated antenna array with feed and calibration networks. These components are integrated together on a multi-layer printed circuit board (PCB). This integration on the PCB allows the array to be smaller, more cost-effective while achieving the required array performance for 5G NR FR1 mMIMO radios and supporting both single and multi-beam applications. The antenna array utilizes electrically small antennas with high-permittivity dielectrics to minimize both size and mutual coupling effects.

### CROSS-REFERENCE TO RELATED APPLICATION

The present application claims priority to U.S. Provisional Patent Application No. 63/610,453, entitled “INTEGRATED ANTENNA ARRAY WITH FEED AND CALIBRATION NETWORKS” filed on Dec. 15, 2023, the contents of which are incorporated herein by reference in their entirety.

### FIELD

The disclosure relates to the field of telecommunications, and more specifically to an antenna array for use with cellular networks.

### BACKGROUND

As demand for data and speed increases from cellular devices, so does the need for better telecommunications standards. Today, 5G New Radio (NR) is the fastest standard, having both lower frequencies (FR1) and higher frequencies (FR2). For 5G mMIMO radios capable of beamforming require antenna arrays.

Unfortunately, many of the 5G NR FR1 mMIMO antenna arrays have a larger physical size due to the radio operating frequency and the number of antenna elements in the array itself. Some of those arrays use elevated patch antennas with air gaps, such as the one shown in FIG. 14, which also contribute to larger physical dimensions. These antenna arrays are so large that they cannot practically accommodate dummy antennas, which would contribute to an increased size of the array. However, dummy antennas are useful and typically serve to minimize edge effects on signal radiation and improve beam performance.

Therefore, there is currently a need for a smaller, more compact and cost-effective 5G NR FR1 mMIMO antenna arrays, preferably one that supports dual polarization and that is comprised of live antennas surrounded by dummy antennas. The present disclosure describes such an antenna array, which comprises an integrated antenna array with feed and calibration networks, whereby the antenna elements are designed and soldered on the antenna board as components and the antenna board preferably consists of a low-cost multi-layer PCB with integrated feed and calibration networks.

### SUMMARY

In an aspect, the present disclosure provides an integrated antenna array comprising: a plurality of antennas to transmit and receive a signal; a calibration network electrically connected to the plurality of antennas; and, a feed network electrically connected to the calibration network and the plurality of antennas, wherein the plurality of antennas, the calibration network and the feed network are integrated together on a multi-layer printed circuit board assembly (PCBA) to reduce a physical size of the integrated antenna array.

### BRIEF DESCRIPTION OF THE DRAWINGS

The following figures serve to illustrate various embodiments of features of the disclosure. These figures are illustrative and are not intended to be limiting.

FIG. 1A is a schematic top view of an antenna array, according to an embodiment of the present disclosure;

FIG. 1B is circuit diagram of a feed network for the antenna array of FIG. 1A, according to an embodiment of the present disclosure;

FIG. 2 is circuit diagram of a calibration network for the antenna array of FIG. 1A, according to an embodiment of the present disclosure;

FIG. 3A is a perspective view of the antenna array of FIG. 1, according to an embodiment of the present disclosure;

FIG. 3B is a perspective view of an antenna array within a radome, according to an embodiment of the present disclosure;

FIG. 4 is a cross-sectional side view along the lines FIG. 4-FIG. 4 shown in FIG. 3B, according to an embodiment of the present disclosure;

FIG. 5A is a top view of a single polarization patch antenna having a single feeding via for use with the present antenna array, according to an embodiment of the present disclosure;

FIG. 5B is a top view of a dual polarization patch antenna having two feeding vias for use with the present antenna array, according to an embodiment of the present disclosure;

FIG. 6 is an underside view of the patch antenna of FIG. 5A, according to an embodiment of the present disclosure;

FIG. 7 is a graphical representation of a broadside beam that can be generated by the antenna array, according to an embodiment of the present disclosure;

FIG. 8 is a graphical representation of a 30-degree horizontal plane beam that can be generated by the antenna array, according to an embodiment of the present disclosure;

FIG. 9 is a graphical representation of a 60-degree horizontal plane beam that can be generated by the antenna array, according to an embodiment of the present disclosure;

FIG. 10 is a graphical representation of a dual-beam in the horizontal plane that can be generated by the antenna array, according to an embodiment of the present disclosure;

FIG. 11 is a graphical representation of a 30-degree vertical plane beam that can be generated by the antenna array, according to an embodiment of the present disclosure;

FIG. 12 is the antenna array surrounded by the radome of FIG. 3, the antenna array emitting a broadside beam, according to an embodiment of the present disclosure;

FIG. 13 is the antenna array surrounded by the radome of FIG. 3, the antenna array emitting a 30-degree horizontal plane beam, according to an embodiment of the present disclosure; and,

FIG. 14 is an image of a conventional mMIMO antenna array with air gaps, according to the prior art.

### DETAILED DESCRIPTION

The following embodiments are merely illustrative and are not intended to be limiting. It will be appreciated that various modifications and/or alterations to the embodiments described herein may be made without departing from the disclosure and any modifications and/or alterations are within the scope of the contemplated disclosure.

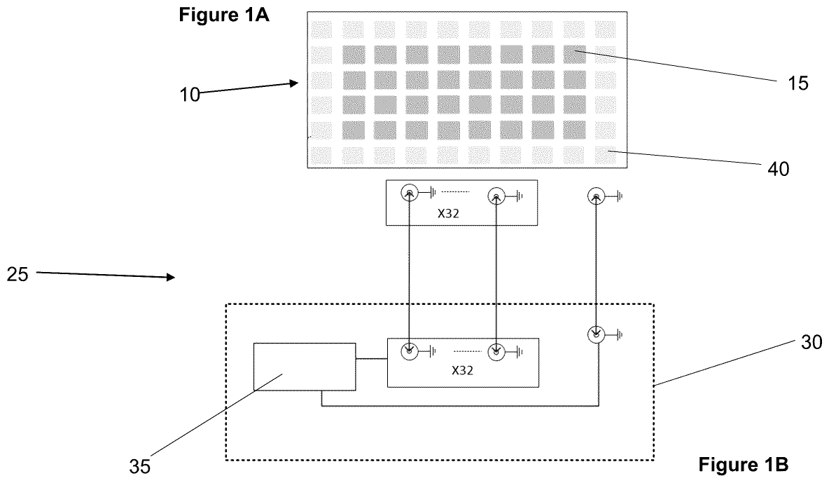

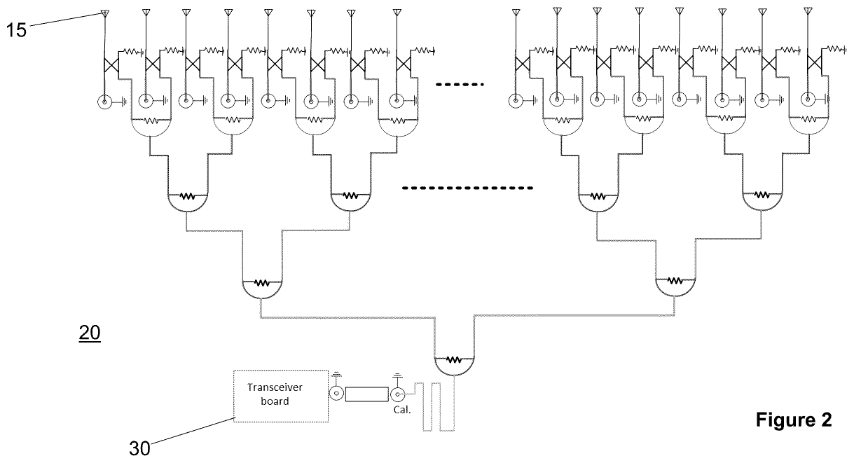

With reference to FIGS. 1A, 1B and 2 and according to an embodiment of the present disclosure, an integrated antenna array 10 is shown comprising a plurality of patch antennas 15 to transmit and receive a signal, a calibration network 20 electrically connected to the antennas 15 and a feed network 25 electrically connected to the antennas 15 and the calibration network 20. In a preferred embodiment, the calibration and feed networks 20, 25 are integrated within an antenna array board 30, the antenna array board 30 in electrical connection with the antennas 15 and comprising a transceiver 35. As shown, the antenna array 10 has a plurality of antennas 15 surrounded by dummy antennas 40. These dummy antennas 40 minimize the undesirable edge effects on signal radiation and improve beam performance. Together, the antennas 15 and calibration and feed networks 20, 25 are integrated together on a multi-layer printed circuit board assembly (PCBA). This type of integrated antenna array 10 is preferably optimal for 5G NR FR1 operation. A worker skilled in the art would appreciate that the antennas 15 are surface mount devices (SMD), which allows easy installation and soldering onto the PCBA.

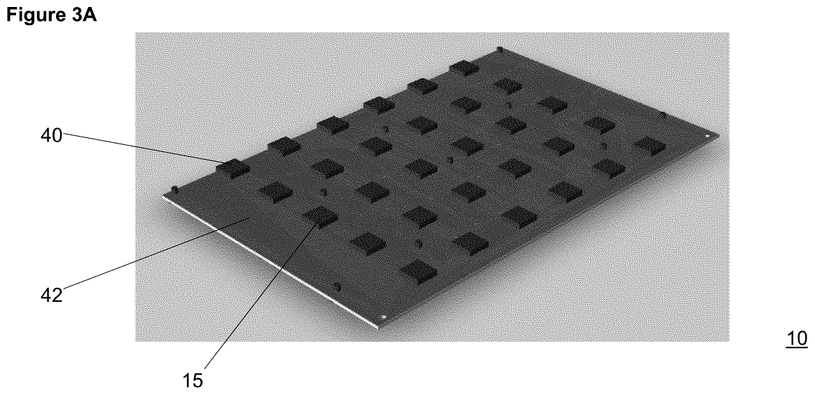

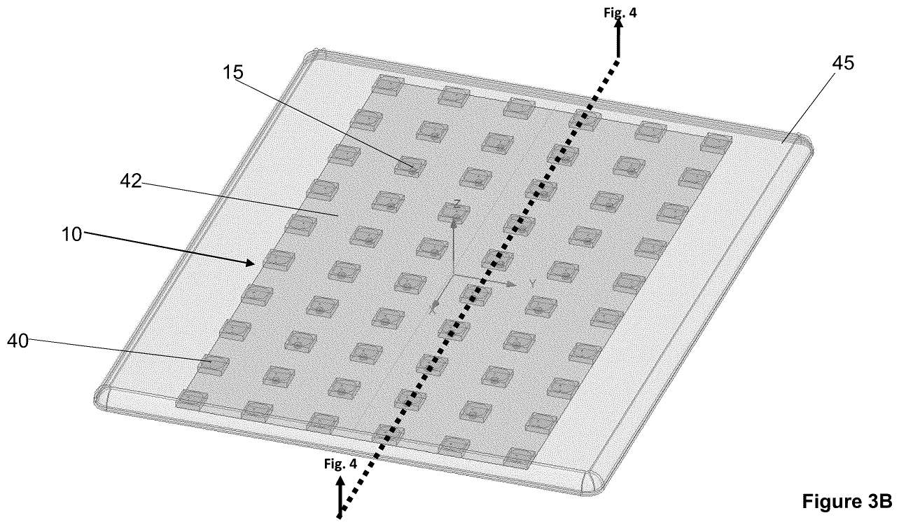

With reference to FIGS. 3A, 3B and 4 and according to an embodiment of the present disclosure, an integrated antenna array 10 is shown, the array 10 having a plurality of antennas 15 and dummy antennas 40 positioned on a printed circuit board (PCB) 42. More specifically, FIG. 3B shows the array 10 contained within a radome 45, the radome 45 being generally cuboid shape with rounded edges. The array 10 supports both single and multi-beam operations whereby each beam can be controlled independently.

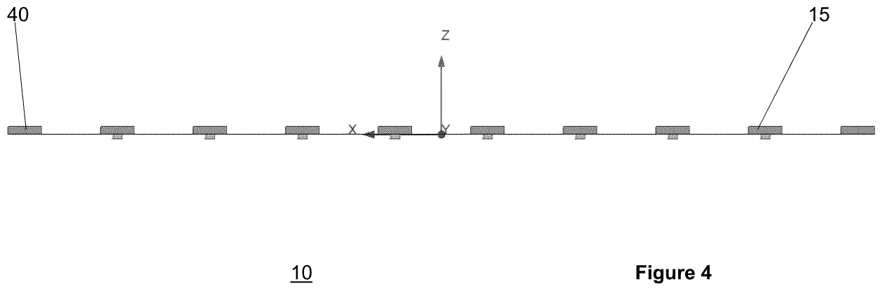

With reference to FIGS. 5A and 5B and according to an embodiment of the present disclosure, enlarged top views of two types of patch antennas are shown. The patch antennas are two-layer PCBs 60, whereby FIG. 5A specifically illustrates the top layer of a single polarization patch antenna 50 having a single feeding via 52, whereas FIG. 5B specifically illustrates the top layer of a dual-polarization patch antenna 55 having two feeding vias 57, 58. The patches 50, 55 are soldered onto a PCB (42 as shown in FIG. 3A) and the feed network (not shown) allows antennas 50, 55 to be electrically connected individually. In this embodiment, the antenna array board is a multilayer printed circuit board (PCB) as shown in FIG. 3A. In a preferred embodiment, low-loss substrates suitable for operating in 5G NR FR1 frequency are used in the PCB (not shown) to reduce the RF loss in the antenna calibration and feed networks (not shown). Each antenna 50, 55 on the PCB (shown in FIG. 3A) is separated one from the other on the PCB by a gap. Using patch antenna as a separate component concept does not cause a weight issue, as the dielectric regions cover only 15-16% of the area on the PCB (not shown). This is owed to the choice of individual patch antenna-element concept and high-permittivity dielectrics. As such, the size of the antennas 50, 55 is minimized, as well as the dielectric supporting the antenna 50, 55. The antennas 50, 55 are comprised of smooth truncated corners to maximize the bandwidth of the via-fed patch.

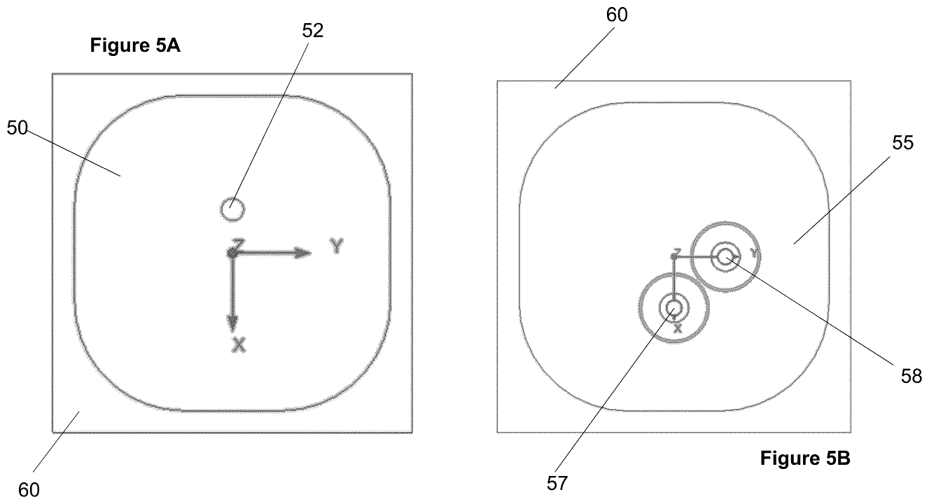

With reference to FIG. 6 and according to an embodiment of the present disclosure, an underside view of the single polarized patch antenna 50 is shown. A plurality of recessed pins 65 are provided, surrounded by a solder mask 70. The feed line 53 is also shown aligned with single feeding via 52 of the antenna 50.

With further reference to FIGS. 5A, 5B and 6, each antenna 50, 55 is configured to be built separately and soldered onto the PCB (not shown). Preferably, the antennas 50, 55 are electrically small (≈λ/5) to allow for maximization of element-to-element spacing, which minimizes mutual coupling effects. A worker skilled in the art would appreciate that the size and dimension of the patch antenna 50, 55 is determined by operating frequency. Isolation of 17-27 dB is achieved between adjacent and nearby elements. The antennas 50, 55 are designed on high-permittivity dielectrics to further minimize their size.

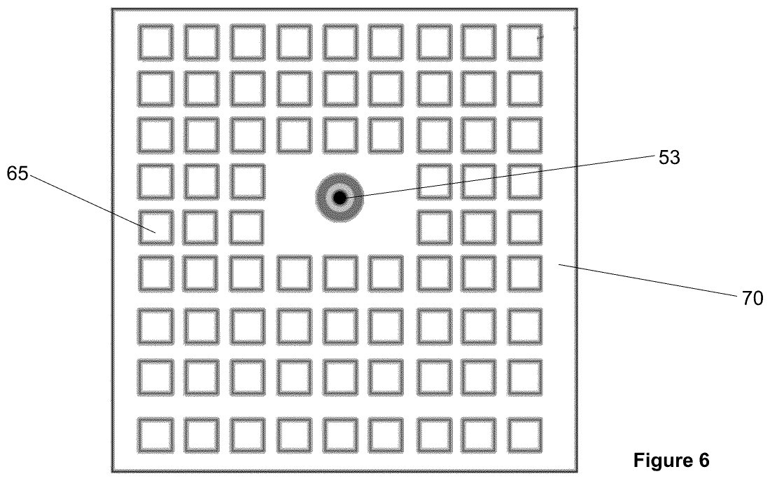

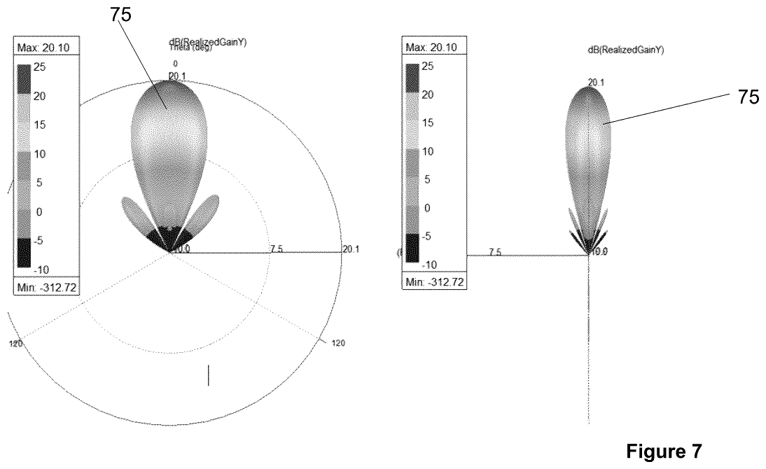

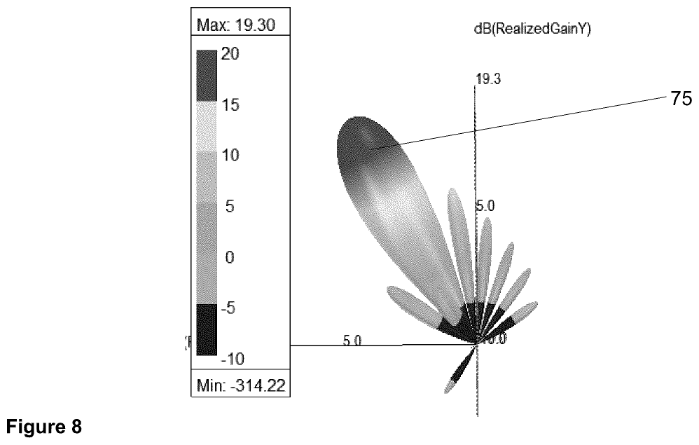

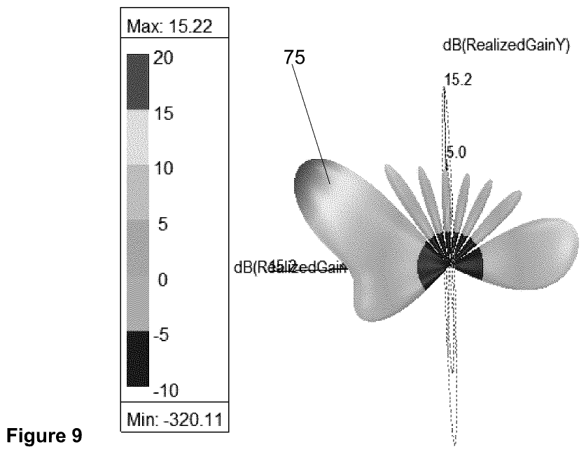

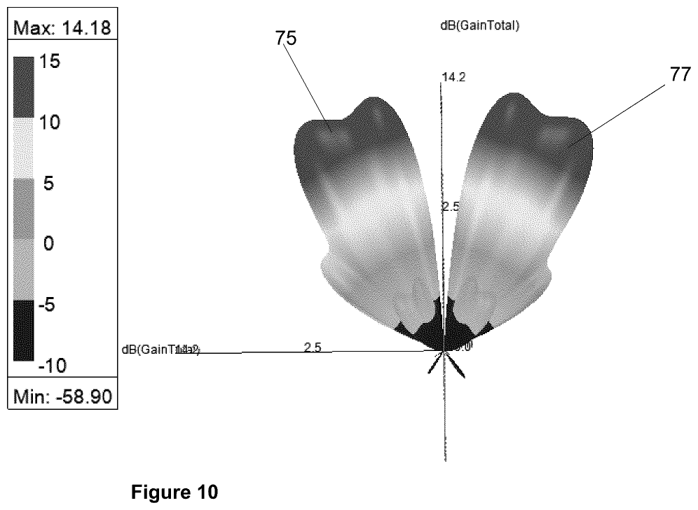

With reference to FIGS. 7, 8, 9, 10 and 11 and according to an embodiment of the present disclosure, various beam steering formations of the antenna array (not shown) are shown. FIG. 7 shown a broadside beam 75, FIG. 8 shown a 30-degree horizontal plane beam 75, FIG. 9 shows a 60-degrees horizontal plane beam 75, FIG. 10 shows dual-beam 75, 77 operation in the horizontal plane, and FIG. 11 shows a 30-degree vertical plane beam 75. As shown, the antenna array (not shown) can send the beam 75 to any arbitrary direction in space within the ±60-degree design target, including any such angles in the horizontal and vertical planes or in between the two planes.

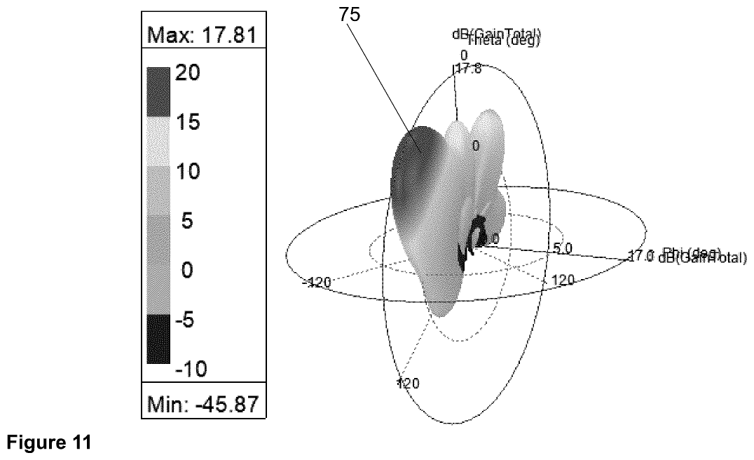

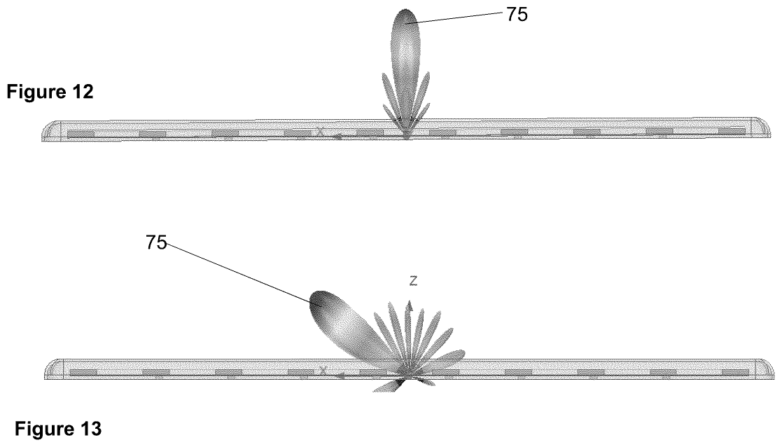

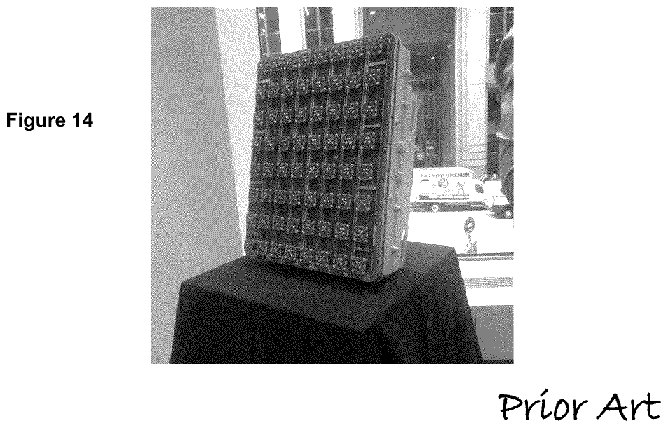

With reference to FIGS. 12 and 13, the antenna arrays 10 within the radome 45 are shown with the superimposed beams 75 whose directions are shown in FIGS. 7 and 8, respectively.

Many modifications of the embodiments described herein as well as other embodiments may be evident to a person skilled in the art having the benefit of the teachings presented in the foregoing description and associated drawings. It is understood that these modifications and additional embodiments are captured within the scope of the contemplated disclosure, which is not to be limited to the specific embodiment disclosed.

1. An integrated antenna array comprising:
a plurality of antennas to transmit and receive a signal;
a calibration network electrically connected to the plurality of antennas; and,
a feed network electrically connected to the calibration network and the plurality of antennas,
wherein the plurality of antennas, the calibration network and the feed network are integrated together on a multi-layer printed circuit board assembly (PCBA) to reduce a physical size of the integrated antenna array.

2. The integrated antenna array of claim 1 wherein the plurality of antennas are patch antennas.

3. The integrated antenna array of claim 1 wherein the plurality of antennas is further comprised of live antennas and dummy antennas to minimize edge effects on signal radiation and improve beam performance.

4. The integrated antenna array of claim 3 wherein the live antennas are surrounded by the dummy antennas to improve beam performance.

5. The integrated antenna array of claim 1 wherein the physical size of the integrated antenna array is directly proportional to an operating frequency.

6. The integrated antenna array of claim 1 wherein the plurality of antennas and the feed and calibration networks are operable in single and multi-beam applications.

7. The integrated antenna array of claim 1 wherein each one of the plurality of antennas is a surface mount device (SMD) individually soldered onto the PCBA and electrically interconnected.

8. The integrated antenna array of claim 7 wherein each one of the plurality of antennas is separated one from another by a gap.

9. The integrated antenna array of claim 7 wherein the dielectric region of the antenna array is <20% of the surface area of the PCBA, thereby reducing a weight of the integrated antenna array.

10. The integrated antenna array of claim 1 configured to operate in a frequency of 5G FR1.

11. The integrated antenna array of claim 1 further comprising a radome, the radome being generally cuboid shape with rounded edge and encasing the integrated antenna array.

12. The integrated antenna array of claim 1 wherein each one of the plurality of antennas are comprised of smooth, truncated corners to maximize a bandwidth of a via-fed patch.

13. The integrated antenna array of claim 2 wherein the patch antennas are at least one of: at least one single polarized patch antenna and at least one dual-polarized patch antenna.

14. The integrated antenna array of claim 2 wherein at least one of the patch antennas is further comprised of:
a plurality of recessed pins on an underside of the patch antennas; and,
a solder mask surrounding the plurality of recessed pins,
wherein a feed line positioned on the underside is aligned with a feeding via.

15. The integrated antenna array of claim 1 wherein each one of the plurality of antennas has an approximate size of λ/5 to maximize element-to-element spacing and minimize mutual coupling.
